(19) United States
(12) Patent Application Publication
(10) Pub. No.: US 2015/0331190 A1
(43) Pub. Date: Nov. 19, 2015

(54) Optical fiber fusion splicer with cutting and positioning function

(71) Applicant: JIEKANGTE SCIENCE & TECHNOLOGY CO., LTD, Chnegdu, Sichuan (CN)

(72) Inventor: Liang Li, Chngdu, Sichuan (CN)

(21) Appl. No.: 14/389,733

(22) PCT Filed: Mar. 29, 2013
(86) PCT No.: PCT/CN2013/073439

§ 371 Date: Sep. 30, 2014

(30) Foreign Application Priority Data
Mar. 31, 2012 (CN) 201210095322.X
Jan. 9, 2013 (CN) 201310007442.4

(51) Int. Cl. G02B 6/255

(52) U.S. Cl. CPC G02B 6/2555; G02B 6/2551

(57) ABSTRACT

An optical fiber fusion splicer with cutting and positioning functions, comprising: a body carrier (1); a sliding block assembly (2); a Z-axis feed-in assembly (3); a hitting hammer assembly (5); a pressing hammer assembly (4); and an optical fiber positioning assembly; wherein the sliding block assembly (2), the Z-axis feed-in assembly (3), the hitting hammer assembly (5), the pressing hammer assembly (4), the optical fiber positioning assembly are all mounted on the body carrier; wherein the optical fiber positioning assembly comprises: two optical fiber positioning holders; two optical fiber fixture respectively hinged to the optical fiber positioning holders; two first rubber pads mounted between the optical fiber positioning holders; and two second rubber pads mounted on the hitting hammer assembly, wherein the second rubber pads respectively cooperate with the first rubber pads.

### CROSS REFERENCE OF RELATED APPLICATION

This is a U.S. National Stage under 35 U.S.C 371 of the International Application PCT/CN2013/073439, filed Mar. 29, 2013, which claims priority under 35 U.S.C. 119(a-d) to CN 201210095322.X, filed Mar. 31, 2012; and CN 201310007442.4, filed Jan. 9, 2013.

### BACKGROUND OF THE PRESENT INVENTION

1. Field of Invention

The present invention relates to a technical field of optical fiber splicing, and more particularly to an optical fiber fusion splicer with cutting and positioning functions.

2. Description of Related Arts

The optical fiber fusion splicer is a communication engineering equipment which melts two ends of optical fibers with heat released by an electric arc, and gently moves forwards with collimation principle at the same time, so as to couple optical fiber mode fields. The optical fiber fusion splicer is widely used in communication engineering construction, maintenance, and communication equipment manufacture. In the 1970s, the first optical fiber fusion splicer was born in Germany's Siemens Company. The optical fiber fusion splicer initially uses acetylene flame for splicing. With gradual development, a location of an optical fiber splice end face (after cutting) in a three-dimensional space (X, Y, Z axis) is observed through a microscope and manually adjusted for precision alignment. After meeting the requirements, the optical fiber moves forwards (along the Z axis) in a high-temperature space formed by discharging electrodes, in such a manner that splice parts are melted and are spliced together. From the late 1980s, through constant technological evolution, CCD imaging and image analysis techniques have displaced the manual microscopic observation; stepper motor and its precision propulsion technology have displaced manual tuning alignment. With the continuous performance improvement of single chip microcomputer and development of related technologies, performance and efficiency of optical fiber fusion splicer are greatly improved. Price of the equipment also dropped from 50˜67 thousand dollars in the 1990s to 3.3˜10 thousand dollars due to adequate market competition.

Conventionally, there are about 7˜8 brands of fiber fusion splicers in the market, with almost the same working principle and processes, namely

(1) preparing optical fiber end face, wherein before splicing, an optical fiber is cut by a cutter for preparing an end face whose cutting face is perpendicular to an axis, which is the only method for alignment with the end face as an interface during splicing; and

(2) placing the optical fibers for splicing, wherein after cutting, the optical fibers are placed in a V-shaped groove of a fusion splicer, a fixture is applied thereon before pressing a splicing button; a system obtains a three-dimensional image of the optical fiber through lens and a CCD, and accordingly analyzes and controls a mechanical system of the fusion splicer to adjust positions of the optical fibers and drives the optical fibers to move towards each other; movement is stopped when a gap between the optical fiber end faces is suitable, and an initial gap is set; the fusion splicer measures and displays an cutting angle; after setting the initial gap, a fiber core or sheath is aligned; then the fusion splicer decreases the gap (which is the last gap setting), an electric arc generated by high voltage discharging splices the two optical fibers; at last, a microprocessor calculates a loss and displays a loss value on a displayer for completing splicing.

The present invention further improves an optical fiber fusion splicer in a Chinese patent application, No. 2012100953322.X. In CN 2012100953322.X, non-spliced optical fibers are fixed and positioned by a positioning mechanism. The non-spliced optical fibers are crossly and diagonally placed on an optical fiber positioning assembly of the positioning mechanism. The cut optical fibers return to original positions and are aligned with own stresses. However, the optical fibers are not easy to be aligned if the optical fibers return to the original positions and are aligned with own stresses.

The present invention has a simple structure, reliable performance, and sufficient cost advantage, and is especially suitable for FTTH (fiber to the home) construction.

### SUMMARY OF THE PRESENT INVENTION

An object of the present invention is to provide an optical fiber fusion splicer with cutting and positioning functions, which solves a problem that alignment of non-spliced optical fibers after being cut is not precise, thereby decreasing splicing quality.

Accordingly, in order to accomplish the above object, the present invention provides an optical fiber fusion splicer with cutting and positioning functions, comprising:

a body carrier; a sliding block assembly; a Z-axis feed-in assembly; a hitting hammer assembly; a pressing hammer assembly; and an optical fiber positioning assembly; wherein the sliding block assembly, the Z-axis feed-in assembly, the hitting hammer assembly, the pressing hammer assembly, the optical fiber positioning assembly are all mounted on the body carrier;

wherein the optical fiber positioning assembly comprises:

two optical fiber positioning holders;

two optical fiber fixture respectively hinged to the optical fiber positioning holders;

two first rubber pads mounted between the optical fiber positioning holders; and

two second rubber pads mounted on the hitting hammer assembly, wherein the second rubber pads respectively cooperate with the first rubber pads;

wherein the optical fiber positioning holders are respectively a left optical fiber positioning holder and a right optical fiber positioning holder; both the left optical fiber positioning holder and the right optical fiber positioning holder have a first V-shaped groove thereon; a non-spliced optical fiber is provided in the first V-shaped grooves and on the first rubber pads, and is fixed with the first rubber pads upwards and the second rubber pads downwards.

Preferably, during splicing, the Z-axis feed-in assembly enlarges an interval between the cut optical fibers for avoiding that end faces of the cut optical fibers contact with and damage each other, then the Z-axis feed-in assembly narrows the interval before discharging and splicing.

Preferably, the Z-axis feed-in assembly comprises a first micro-shifter, for driving the optical fiber positioning holders to move, so as to drive the optical fiber to axially move.

Preferably, the sliding block assembly comprises: a carrier, a cutting blade, a position adjustment holder, a second V-shaped groove and an electrode mounted on the second V-shaped groove, wherein the cutting blade is mounted on the carrier, the second V-shaped groove is provided on the position adjustment holder, and the position adjustment holder is mounted on the carrier.

Preferably, the pressing hammer assembly comprises: a pressing hammer, a pressing hammer holder, and a spring; wherein the pressing hammer holder is mounted on the body carrier and is coaxial with the sliding block assembly, the pressing hammer presses the non-spliced optical fiber against the first V-shaped groove with a pressure generated by the spring.

Preferably, for suiting different types of optical fibers and splicing optical fibers with different end structures, a corresponding optical fiber positioning holder should be utilized. The optical fiber positioning holders for common types of optical fibers are prepared for each optical fiber fusion splicer.

Preferably, the pressing hammer is controlled manually or electrically.

Preferably, the optical fiber fusion splicer further comprises an electrical control system, wherein the electrical control system comprises:

a CPU; a position sensor; a second micro-shifter; two discharge electrodes, a discharge control module, a high voltage coil; and an auxiliary functional module;

wherein the position sensor is mounted on the sliding block assembly which cuts and splices the optical fiber; the second micro-shifter is connected to the CPU and is mounted on the optical fiber fixture; the discharge electrodes are mounted on the sliding block assembly; the discharge control module is connected to the CPU for controlling the discharge electrodes to discharge; the high voltage coil is connected to a power module for supplying the discharge electrodes with electricity; the power module is connected to the CPU.

Preferably, the position sensor sends a signal to the CPU for aiming discharge at a position of the non-spliced optical fiber; the CPU analyzes and processes the signal and then drives the second micro-shifter to move along a Z-axis with a certain distance; at the same time, the CPU orders the discharge control module to control the high voltage coil for supplying discharge, so as to splice the optical fiber.

A principle of the present invention is as follows. Before cutting, two cleaned but non-spliced fibers are oppositely placed with the same axis, the second rubber pads on the hitting hammer assembly cooperate with the first rubber pads between the optical fiber fixtures for fixing the optical fibers. The sliding block assembly cuts the two optical fibers at the same time, and then the hitting hammer assembly breaks the non-spliced optical fibers for completing cutting. The pressing hammer of the pressing hammer assembly presses the cut optical fibers against the second V-shaped groove for fixing the optical fibers.

During splicing, before the optical fibers returns to original positions after being hit by the hitting hammer, the Z-axis feed-in assembly enlarges an interval between the cut optical fibers for avoiding that end faces of the cut optical fibers contact with and damage each other. Then the Z-axis feed-in assembly narrows the interval before discharging and splicing, so as to ensure splicing quality. The second V-shaped groove, the cutting blade and a slider are integrated by the sliding block assembly, so as to better align the non-spliced optical fibers. Since the whole operation process is provided within the sliding block assembly, splicing requirements along X and Y-axes are satisfied with precision of the sliding block assembly.

Therefore, with the present invention, two uncut optical fibers are able to be rapidly and conveniently processed into optical fibers satisfying requirements before discharge splicing in an X\Y\Z three-dimensional space. The optical fibers in such state are able to be spliced just according to preset discharge parameters and Z-axis feed-in parameters of electrode discharging. After several tests by the inventors, a qualification rate of splicing joints is not less than 92%. Therefore, splicing according to the present invention is fully able to satisfy conventional engineering requirements. It should be noticed that during splicing, no conventional optical lens, CCD, or image processing system is involved.

Compared with the conventional technology, advantages of the present invention are as follows.

Firstly, a method, which obtains a dynamic splicing image and analyzes the dynamic splicing image for driving and splicing, is abandoned. As a replacement, the optical fibers are positioned according to precision of the sliding block assembly. Before cutting, two cleaned but non-spliced fibers are oppositely placed with a same axis in the first V-shaped groove of the optical fiber positioning holder. The sliding block assembly cuts the two optical fibers at the same time, and then the hitting hammer assembly breaks the non-spliced optical fibers for completing cutting. The pressing hammer presses the cut optical fibers, which is slightly bended, against the second V-shaped groove of the sliding block assembly for fixing the optical fibers. As a result, the optical fibers are cut and are aligned by the second V-shape groove, the pressing hammer, the first and second rubber pads after being cut. Splicing is provided by discharging and driving the end faces to move forwards.

Secondly, the Z-axis feed-in assembly enlarges an interval between the end faces formed by cutting. Then the Z-axis feed-in assembly narrows the interval before discharging and splicing, so as to ensure splicing quality. Requirements before discharge splicing are satisfied with precision of the second V-shaped groove, which omits a large number of mechanical and electrical equipments, and greatly simplifies a structure of the conventional optical fiber fusion splicer. According to the present invention, the structure is simple and production costs are reduced. In the meantime, costs and operating procedures are reduced, which enables single-person operation.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an optical fiber fusion splicer with cutting and positioning functions according to a preferred embodiment of the present invention.

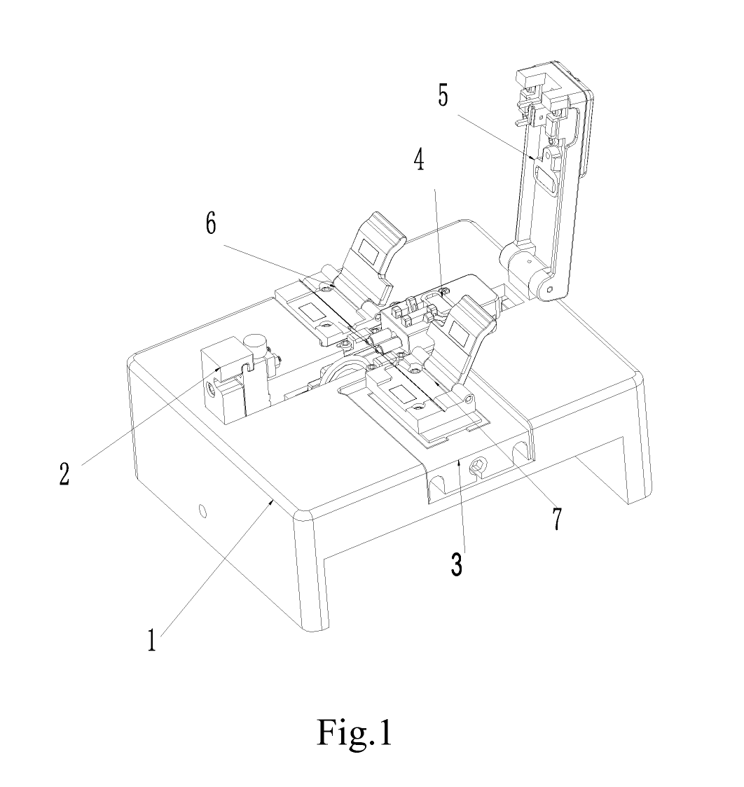

FIG. 2 is a structural view of a sliding block assembly according to the preferred embodiment of the present invention.

FIG. 3 is a structural view of a hitting hammer assembly according to the preferred embodiment of the present invention.

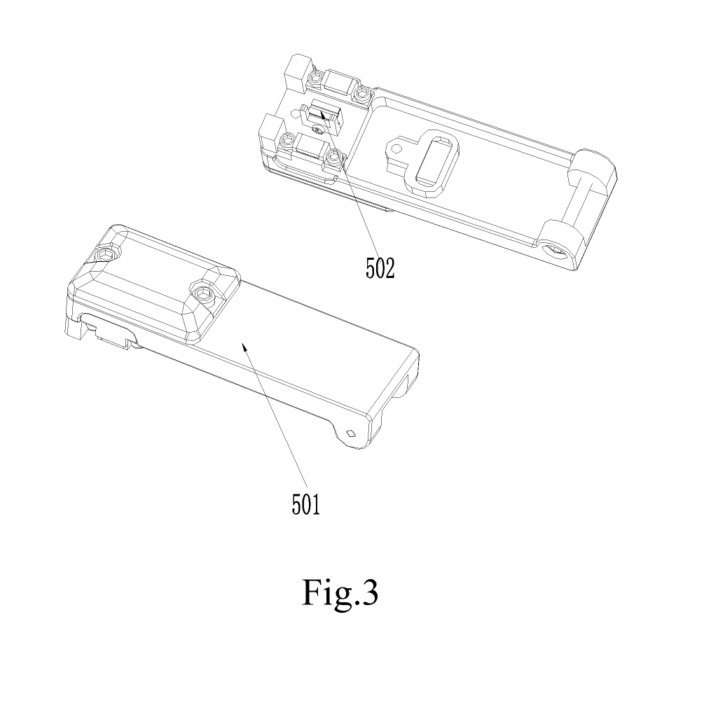

FIG. 4 is a schematic view of an electrical control system according to the preferred embodiment of the present invention.

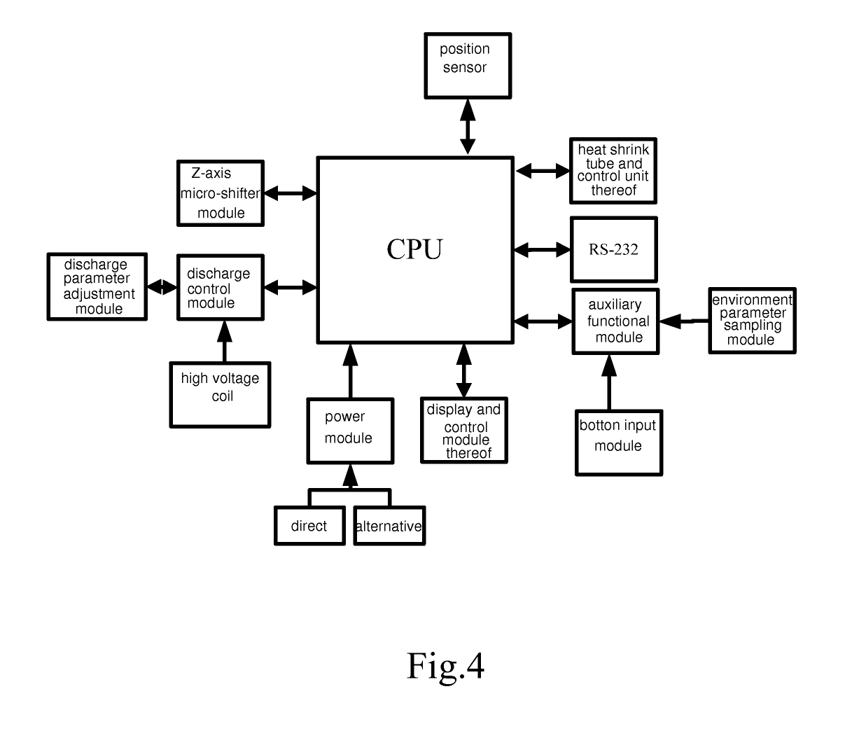

Reference numbers: 1—body carrier, 2—sliding block assembly, 3—Z—axis feed—in assembly, 4—pressing hammer assembly, 5—hitting hammer assembly, 6—left optical fiber positioning holder, 7—right optical fiber positioning holder, 201—second V—shaped groove, 202—cutting blade, 203—position adjustment holder, 204—carrier, 501—hitting hammer assembly, 502—hitting hammer.

### DETAILED DESCRIPTION OF THE PREFERRED EMBODIMENT

Referring to the drawings and preferred embodiments, the present invention is further illustrated, comprising:

a body carrier; a sliding block assembly; a Z-axis feed-in assembly; a hitting hammer assembly; a pressing hammer assembly; and an optical fiber positioning assembly; wherein the sliding block assembly, the Z-axis feed-in assembly, the hitting hammer assembly, the pressing hammer assembly, the optical fiber positioning assembly are all mounted on the body carrier;

wherein the optical fiber positioning assembly comprises:

two optical fiber positioning holders;

two optical fiber fixture respectively hinged to the optical fiber positioning holders;

two first rubber pads mounted between the optical fiber positioning holders; and

two second rubber pads mounted on the hitting hammer assembly, wherein the second rubber pads respectively cooperate with the first rubber pads;

wherein the optical fiber positioning holders are respectively a left optical fiber positioning holder and a right optical fiber positioning holder; both the left optical fiber positioning holder and the right optical fiber positioning holder have a first V-shaped groove thereon; a non-spliced optical fiber is provided in the first V-shaped grooves and on the first rubber pads, and is fixed with the first rubber pads upwards and the second rubber pads downwards.

### Preferred Embodiment 1

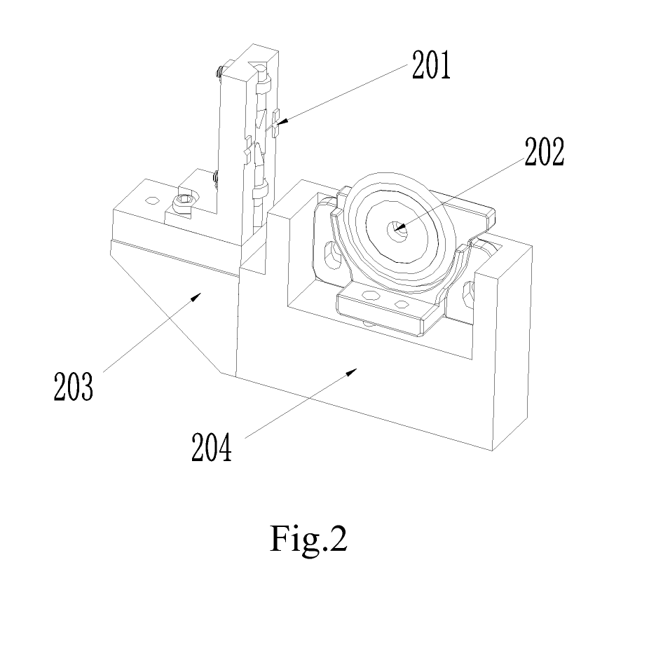

Referring to FIG. 2, the sliding block assembly comprises: a carrier, a cutting blade, a position adjustment holder, a second V-shaped groove and an electrode mounted on the second V-shaped groove, wherein the cutting blade is mounted on the carrier, the second V-shaped groove is provided on the position adjustment holder, and the position adjustment holder is mounted on the carrier.

The cutting blade is mounted on a blade holder by bolts, and the blade holder is mounted on the sliding block assembly by bolts, in such a manner that the cutting blade is able to be detached at any time for maintenance. An overall shape of the second V-shaped groove is in an L form, and the second V-shaped groove is mounted on the position adjustment holder by bolts, in such a manner that the second V-shaped groove is easy to be detached and replaced when broken.

A positioning bolt and a position sensor are mounted on the carrier for positioning the electrodes, the optical fibers and the cutting blade. A convex part is placed on a side of the carrier, in such a manner that the sliding block assembly is able to stably move along a sliding chamber of the body carrier.

### Preferred Embodiment 2

The pressing hammer assembly comprises: a pressing hammer, a pressing hammer holder, and a spring; wherein the pressing hammer holder is mounted on the body carrier and is coaxial with the sliding block assembly, the pressing hammer presses the non-spliced optical fiber along a direction of the spring against the first V-shaped groove with a pressure generated by the spring.

### Preferred Embodiment 3

The hitting hammer assembly comprises: a hitting hammer and a hitting hammer body; wherein the hitting hammer is mounted on the hitting hammer body. The hitting hammer is placed between the second rubber pads and is aimed right at the non-spliced optical fibers. The hitting hammer body is movably connected to the body carrier by bolts. After the optical fiber is vertically cut by the cutting blade on the sliding block assembly, an opposite side of a cut part of the optical fiber is hit by the hitting hammer for separating the optical fiber at the cut part. The hitting hammer is mounted on the body carrier by the hitting hammer body. With conventional methods, the hitting hammer is manually or automatically controlled to vertically move downwards on the body carrier. Therefore, the present invention covers all hitting hammers which vertically move downwards and break the cut optical fibers. A front part of the hitting hammer is made of a buffer material such as rubber for contacting with the optical fiber.

### Preferred Embodiment 4

A splicing method comprises steps of:

a) stripping an optical cable, and passing optical fibers through a heat shrink tube one by one;

b) stripping a casting layer of the optical fiber and cleaning the optical fiber;

c) placing the cleaned optical fiber at a side of a fusion splicer, pressing a stripped part of the casting layer by an optical fiber fixture, and fixing the stripped optical fiber with the optical fiber fixture completely by an optical fiber positioning holder;

d) repeating the step c) for correctly placing an optical fiber at another side;

e) driving a hitting hammer assembly downwards, in such a manner that second rubber pads on the hitting hammer assembly respectively cooperate with first rubber pads between optical fiber positioning holders for pressing and fixing the optical fibers;

f) pushing a sliding block assembly to a fixing position of the optical fibers for cutting and breaking the optical fibers; and

g) pressing a splicing button for executing an electrode discharge program and a Z-axis enlarging and narrowing program, so as to complete splicing.

### Preferred Embodiment 5

The optical fiber fusion splicer further comprises an electrical control system, comprising:

a CPU; a position sensor mounted on the sliding block assembly which cuts and splices the optical fibers; wherein the electrical control system further comprises: a second micro-shifter; two discharge electrodes, a discharge control module, a discharge parameter adjustment module, a high voltage coil; and an auxiliary functional module;

the second micro-shifter is connected to the CPU and is mounted on the optical fiber fixture; the discharge electrodes are mounted on the slider; the discharge control module is connected to the CPU for controlling the discharge electrodes to discharge, the discharge control module is also connected to the discharge parameter adjustment module; the high voltage coil is connected to a power module for supplying the discharge electrodes with electricity; the power module is connected to the CPU. The power module has an alternating mode and a direct mode. The position sensor sends a signal to the CPU for aiming discharge at a position of the non-spliced optical fiber; the CPU analyzes and processes the signal and then drives the second micro-shifter to move along a Z-axis with 5˜30 μm; at the same time, the CPU orders the discharge control module to control the high voltage coil for supplying discharge, so as to splice the optical fiber.

The CPU also communicates with the auxiliary functional module, a display and input control module, the heat shrink tube, a control unit, and an RS-232 interface. The auxiliary functional module comprises an environment parameter sampling module, a button input module and a melting furnace control module, wherein the environment parameter sampling module samples pressure, temperature and humidity.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-6. (canceled)

7. An optical fiber fusion splicer with cutting and positioning functions, comprising:
a body carrier; a sliding block assembly; a Z-axis feed-in assembly; a hitting hammer assembly; a pressing hammer assembly; and an optical fiber positioning assembly; wherein said sliding block assembly, said Z-axis feed-in assembly, said hitting hammer assembly, said pressing hammer assembly, said optical fiber positioning assembly are all mounted on said body carrier;
wherein said optical fiber positioning assembly comprises:
two optical fiber positioning holders;
two optical fiber fixture respectively hinged to said optical fiber positioning holders;
two first rubber pads mounted between said optical fiber positioning holders; and
two second rubber pads mounted on said hitting hammer assembly, wherein said second rubber pads respectively cooperate with said first rubber pads;
wherein said optical fiber positioning holders are respectively a left optical fiber positioning holder and a right optical fiber positioning holder; both said left optical fiber positioning holder and said right optical fiber positioning holder have a first V-shaped groove thereon; a non-spliced optical fiber is provided in said first V-shaped grooves and on said first rubber pads, and is fixed with said first rubber pads upwards and said second rubber pads downwards.

8. The optical fiber fusion splicer, as recited in claim 7, wherein said Z-axis feed-in assembly comprises a first micro-shifter, for driving said optical fiber positioning holders to move, so as to drive the optical fiber to axially move.

9. The optical fiber fusion splicer, as recited in claim 7, wherein said sliding block assembly comprises: a carrier, a cutting blade, a position adjustment holder, a second V-shaped groove and an electrode mounted on said second V-shaped groove, wherein said cutting blade is mounted on said carrier, said second V-shaped groove is provided on said position adjustment holder, and said position adjustment holder is mounted on said carrier.

10. The optical fiber fusion splicer, as recited in claim 7, wherein said pressing hammer assembly comprises: a pressing hammer, a pressing hammer holder, and a spring; wherein said pressing hammer holder is mounted on said body carrier and is coaxial with said sliding block assembly, said pressing hammer presses the non-spliced optical fiber against said first V-shaped groove with a pressure generated by said spring.

11. The optical fiber fusion splicer, as recited in claim 7, further comprising an electrical control system, wherein said electrical control system comprises:
a CPU; a position sensor; a second micro-shifter; two discharge electrodes, a discharge control module, a high voltage coil; and an auxiliary functional module;
wherein said position sensor is mounted on said sliding block assembly which cuts and splices the optical fiber; said second micro-shifter is connected to said CPU and is mounted on said optical fiber fixture; said discharge electrodes are mounted on said sliding block assembly; said discharge control module is connected to said CPU for controlling said discharge electrodes to discharge; said high voltage coil is connected to a power module for supplying said discharge electrodes; said power module is connected to said CPU.

12. The optical fiber fusion splicer, as recited in claim 8, further comprising an electrical control system, wherein said electrical control system comprises:
a CPU; a position sensor; a second micro-shifter; two discharge electrodes, a discharge control module, a high voltage coil; and an auxiliary functional module;
wherein said position sensor is mounted on said sliding block assembly which cuts and splices the optical fiber; said second micro-shifter is connected to said CPU and is mounted on said optical fiber fixture; said discharge electrodes are mounted on said sliding block assembly; said discharge control module is connected to said CPU for controlling said discharge electrodes to discharge; said high voltage coil is connected to a power module for supplying said discharge electrodes; said power module is connected to said CPU.

13. The optical fiber fusion splicer, as recited in claim 9, further comprising an electrical control system, wherein said electrical control system comprises:
a CPU; a position sensor; a second micro-shifter; two discharge electrodes, a discharge control module, a high voltage coil; and an auxiliary functional module;
wherein said position sensor is mounted on said sliding block assembly which cuts and splices the optical fiber; said second micro-shifter is connected to said CPU and is mounted on said optical fiber fixture; said discharge electrodes are mounted on said sliding block assembly; said discharge control module is connected to said CPU for controlling said discharge electrodes to discharge; said high voltage coil is connected to a power module for supplying said discharge electrodes; said power module is connected to said CPU.

14. The optical fiber fusion splicer, as recited in claim 10, further comprising an electrical control system, wherein said electrical control system comprises:
a CPU; a position sensor; a second micro-shifter; two discharge electrodes, a discharge control module, a high voltage coil; and an auxiliary functional module;
wherein said position sensor is mounted on said sliding block assembly which cuts and splices the optical fiber; said second micro-shifter is connected to said CPU and is mounted on said optical fiber fixture; said discharge electrodes are mounted on said sliding block assembly; said discharge control module is connected to said CPU for controlling said discharge electrodes to discharge; said high voltage coil is connected to a power module for supplying said discharge electrodes; said power module is connected to said CPU.

15. The optical fiber fusion splicer, as recited in claim 11, wherein said position sensor sends a signal to said CPU for aiming discharge at a position of the non-spliced optical fiber; said CPU analyzes and processes said signal and then drives said second micro-shifter to move along a Z-axis with a certain distance; at the same time, said CPU orders said discharge control module to control said high voltage coil for supplying discharge, so as to splice the optical fiber.

16. The optical fiber fusion splicer, as recited in claim 12, wherein said position sensor sends a signal to said CPU for aiming discharge at a position of the non-spliced optical fiber; said CPU analyzes and processes said signal and then drives said second micro-shifter to move along a Z-axis with a certain distance; at the same time, said CPU orders said discharge control module to control said high voltage coil for supplying discharge, so as to splice the optical fiber.

17. The optical fiber fusion splicer, as recited in claim 13, wherein said position sensor sends a signal to said CPU for aiming discharge at a position of the non-spliced optical fiber; said CPU analyzes and processes said signal and then drives said second micro-shifter to move along a Z-axis with a certain distance; at the same time, said CPU orders said discharge control module to control said high voltage coil for supplying discharge, so as to splice the optical fiber.

18. The optical fiber fusion splicer, as recited in claim 14, wherein said position sensor sends a signal to said CPU for aiming discharge at a position of the non-spliced optical fiber; said CPU analyzes and processes said signal and then drives said second micro-shifter to move along a Z-axis with a certain distance; at the same time, said CPU orders said discharge control module to control said high voltage coil for supplying discharge, so as to splice the optical fiber.
